(19) United States
(12) Patent Application Publication
(10) Pub. No.: US 2011/0238256 A1
(43) Pub. Date: Sep. 29, 2011

(54) VEHICLE SEAT, IN PARTICULAR MOTOR VEHICLE SEAT

(76) Inventors: Norbert Heeg, Dahn (DE); Andreas Diehl, Otterberg (DE); Jens Schulz, Kaiserslautern (DE)

(21) Appl. No.: 13/133,755

(22) PCT Filed: Nov. 3, 2009
(86) PCT No.: PCT/EP2009/007851

§ 371 Date: Jun. 9, 2011

(30) Foreign Application Priority Data
Dec. 10, 2008 (DE) 10 2008 062 092.0

(51) Int. Cl. G01M 17/00; B60N 2/02

(52) U.S. Cl. 701/29

(57) ABSTRACT

A vehicle seat (1), in particular a motor vehicle seat, includes several devices (11) for adjusting and/or locking at least one seat component of the vehicle seat (1). Each device (11) includes a mechanical component (11a), an electric drive (11b) for driving the mechanical component (11a) and an i-component (11c) which serves at least to control the electric drive (11b) and/or for the diagnosis of the mechanical component (11a).

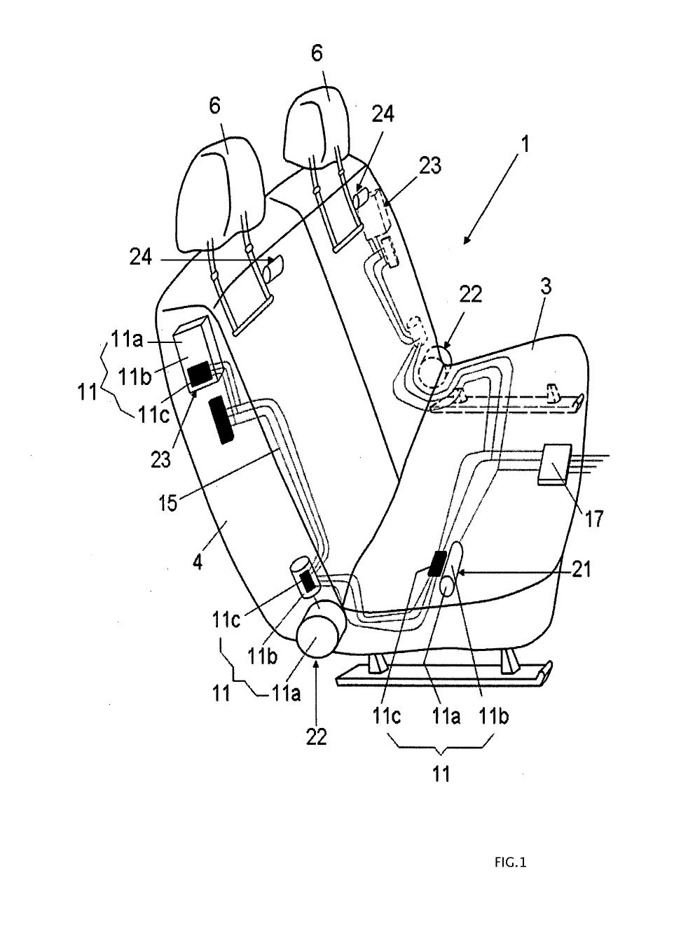

### CROSS REFERENCE TO RELATED APPLICATIONS

This application is a United States National Phase application of International Application PCT/EP2009/007851 and claims the benefit of priority under 35 U.S.C. §119 of German Patent Application DE 10 2008 062 092.0 filed Dec. 10, 2008, the entire contents of which are incorporated herein by reference.

### FIELD OF THE INVENTION

The invention relates to a vehicle seat, in particular a motor vehicle seat, having apparatuses for adjusting and/or locking at least one seat component of the vehicle seat with each apparatus having a mechanical component and an electric drive for driving the mechanical component.

### BACKGROUND OF THE INVENTION

A vehicle seat of this kind is known from DE 198 36 060 B4. The vehicle seat has various electric drives which each drive an adjusting apparatus or locking apparatus. The electric drives are connected to a central controller which, for its part, is activated by means of operator control elements.

### SUMMARY OF THE INVENTION

The invention is based on an object of improving a vehicle seat of the kind cited in the introduction.

According to the invention, a vehicle seat is provided, in particular a motor vehicle seat, having a plurality of apparatuses for adjusting and/or locking at least one seat component of the vehicle seat. Each apparatus has a mechanical component and an electric drive for driving the mechanical component. Each apparatus has an i-module which serves at least to control the electric drive and/or to diagnose the mechanical component.

With each apparatus involved having, in addition to its mechanical component and its electric drive, its own intelligent electronics system in the form of the i-module, direct control of the associated apparatus is allowed by controlling the associated electric drive. The i-module can also (or alternatively) serve to diagnose the electric drive and/or the associated mechanical component. For the purpose of this local diagnosis, at least one sensor, which is connected to the i-module, is provided in the mechanical component. In comparison with a central controller with a high installation space requirement as required in conventional systems, the relatively small i-modules are accommodated in a decentralized manner at suitable locations. The installation spaces obtained in this way are used to provide a higher level of comfort and a higher level of safety for the occupant.

The apparatuses which are present in the vehicle seat can be controlled in decentralized manner by means of the i-modules, which serve as local controllers, by linking the i-modules, for example by means of a data bus. The linked i-modules communicate with one another and match the apparatuses to one another. Integration in an overall system, in particular by virtue of the use of a standardized communication protocol, is possible on account of the use of the i-module. At the same time, comfort and safety are noticeably improved since different apparatuses in the vehicle seat can communicate with one another. Therefore, dependencies within the vehicle seat can be relatively easily illustrated and, in particular, easily matched to different customer requirements.

The invention is explained in greater detail below with reference to an exemplary embodiment which is illustrated in the drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

The single FIGURE shows a schematic illustration of the exemplary embodiment.

### DESCRIPTION OF THE PREFERRED EMBODIMENTS

Referring to the drawings in particular, a vehicle seat 1, which is provided for a rear row of seats of a motor vehicle in the present case, has a seat part 3 and a backrest 4. The arrangement of the vehicle seat 1 within the motor vehicle and its usual direction of travel define the directional information which is used below. A headrest 6 which is seated on the backrest 4 is provided for each seat. The vehicle seat 1 has a plurality of (that is to say at least two) adjusting apparatuses and/or locking apparatuses, called apparatuses 11 for short, by means of which in each case at least one seat component of the vehicle seat 1 can be adjusted and/or locked relative to another seat component of the vehicle seat 1 and/or relative to the vehicle structure. Each apparatus 11 has a mechanical component 11a, an electric drive 11b for driving the mechanical component, and an i-module 11c which serves at least to control the electric drive 11b.

The i-module 11c substantially comprises a programmable and configurable hardware unit (processor and memory) with implemented software for processing incoming and outgoing information, a communications interface with the electric drive 11b (in particular an output for controlling the electric drive 11b and an input for diagnosing the electric drive 11b and/or the mechanical component 11a, that is to say, for example, for accommodating rotation speed-dependent signals of the electric drive 11b) and a communications interface to a data bus 15. A rotation speed control system, for example for an electric drive 11b in which the required torque changes (for example a geared fitting with a self-locking eccentric epicyclic gear mechanism), can also be integrated in the i-module 11c.

The data bus 15 can be, for example, a LIN, CAN, USB, Ethernet bus system or some other bus system. Accordingly, said data bus, including the supply lines, is realized by a three-core (LIN), four-core (CAN, USB) or multi-core cable, that is to say each i-module 11c requires just one connection plug with a corresponding number of cores. Star-like or ring-like lines, possibly with T-shaped branches, are possible. The data bus 15 is connected by means of a gateway 17 to the data bus of the vehicle (in which the vehicle seat 1 is to be installed or is installed). The gateway 17 can be a separate module or can be integrated in an i-module 11c or another component, for example an operator control switch. The i-modules 11c serve as local controllers which allow the apparatuses 11 of the vehicle seat 1 to be controlled in a decentralized manner by virtue of linking by means of the data bus 15.

Various examples of apparatuses 11 are shown in the FIGURE. A longitudinal adjuster 21 (which has seat rails) is provided in the seat part 3, allowing the longitudinal position of the longitudinally adjustable vehicle seat 1 to be adjusted. A backrest adjuster 22 is provided between the backrest 4 and the seat part 3 (in each case on both sides of the vehicle seat), allowing the inclination of the backrests 4 to be adjusted. A backrest locking system 23 is provided at the upper end of the backrest (in each case on both sides of the vehicle seat), allowing the backrest 4 to be locked to the vehicle structure. In addition, a headrest adjuster 24 is provided for each headrest 6 between the backrest locking systems 23, allowing the height of the headrest 6 above the upper edge of the backrest 4 to be adjusted. A height adjuster and inclination adjuster for the seat part 3 can also be provided.

The i-module 11c is preferably arranged physically in the vicinity of the connected electric drive 11b in order to keep the connecting cables short and to reduce the risk of electromagnetic influences. Depending on the available installation space, the relatively small i-component 11c is seated directly on the electric drive 11b or at another point which is not yet occupied by other functions of the vehicle seat 1. The i-module can also be integrated structurally in the electric drive 11b. The i-module 11c preferably diagnoses the apparatus 11 (in particular the mechanical component 11a), that is to say evaluates and possibly logically links various items of information from the mechanical component 11a which are detected there by at least one sensor which is connected to the i-module 11c. An item of information for the occupant or for the overall “vehicle seat” system can be generated from this information. In a modified embodiment, this is the only task of the i-module 11c. Alternatively, the i-module 11c additionally controls the electric drive 11b. The control can be performed as a function of the information from the other apparatuses 11. In the case of a locking apparatus, the i-module 11c can automatically re-lock the mechanical component 11a if initiated by the occupant. The i-module 11c can also be used to control and possibly regulate (for example different speeds, noise optimization, end position control, memorization etc.) different apparatuses 11 in respect of comfort. The situation of an end position being reached can be identified, for example, by an increase in current. When a limit value is exceeded, the electric drive 11b can be switched off, and therefore overloading can be avoided.

The i-modules 11c can communicate with one another and, amongst other things, interchange locking and position information from continuously operating apparatuses 11 and therefore be matched to one another via the data bus 15. This can be used for complex movement sequences in which a plurality of apparatuses 11 interact by the electric drives 11b of the apparatuses 11 involved not being activated at the same time but rather in a specific time sequence, that is to say the electrical drive 11b of a specific apparatus 11 is activated when the apparatus 11 preceding it in the sequence has reached a specific target position. An example of this is free pivoting of the backrest 4 which is to be unlocked and pivoted forward, in combination with a subsequent forward movement of the vehicle seat 1. Matching the apparatuses 11 to a specific time sequence can also be used (for the purpose of protecting the lines) to limit the total current by not all the apparatuses 11 being activated at the same time. The total current, that is to say the current in the entire system, does not increase above the maximum reliable value in this case. A master module can also be provided for matching tasks.

The gateway converts the vehicle information for the network in the vehicle seat 1. Information which is relevant to the vehicle (which has to be forwarded to the occupant or the driver for example) is converted in the opposite direction.

While specific embodiments of the invention have been described in detail to illustrate the application of the principles of the invention, it will be understood that the invention may be embodied otherwise without departing from such principles.

1. A vehicle seat comprising:
at least one seat component; and
a plurality of apparatuses for adjusting and/or locking the at least one seat component, each apparatus having a mechanical component and an electric drive for driving the mechanical component and an i-module which serves at least to control the electric drive and/or to diagnose the mechanical component.

2. The vehicle seat as claimed in claim 1, wherein the i-modules of the plurality of apparatuses are interlinked.

3. The vehicle seat as claimed in claim 2, wherein the i-modules are linked by means of a data bus.

4. The vehicle seat as claimed in claim 3, further comprising a gateway and a vehicle data bus, wherein the data bus is connected by means of the gateway to the vehicle data bus of the vehicle in which the vehicle seat is installed or is to be installed.

5. The vehicle seat as claimed in claim 1, wherein the apparatuses are controlled in a decentralized manner by means of the i-modules which serve as local controllers.

6. The vehicle seat as claimed in claim 2, wherein the i-modules communicate with one another and match the apparatuses to one another.

7. The vehicle seat as claimed in claim 6, wherein the i-modules activate the electric drives of the apparatuses in a specific time sequence.

8. The vehicle seat as claimed in claim 1, wherein the i-module is arranged physically in the vicinity of the connected electric drive or is integrated structurally in the electric drive.

9. The vehicle seat as claimed in claim 5, wherein the i-modules communicate with one another and match the apparatuses to one another.

10. The vehicle seat as claimed in claim 9, wherein the i-modules activate the electric drives of the apparatuses in a specific time sequence.

11. A motor vehicle seat comprising:
seat components;
an apparatus for adjusting and/or locking at least one of the seat components, the apparatus comprising a mechanical component in operative connection with the at least one of the seat components, an electric drive for driving the mechanical component and an i-module for at least one of controlling the electric drive and diagnosing the mechanical component; and
another apparatus for adjusting and/or locking at least one of the seat components, the another apparatus comprising another mechanical component in operative connection with the at least one of the seat components, another electric drive for driving the another mechanical component and another i-module for at least one of controlling the another electric drive and diagnosing the another mechanical component.

12. The vehicle seat as claimed in claim 11, wherein the i-modules of the plurality of apparatuses are interlinked and communicate with one another to exchange at least one of locking and position information.

13. The vehicle seat as claimed in claim 12, wherein the i-modules are linked by an i-module data bus.

14. The vehicle seat as claimed in claim 13, further comprising:
a gateway; and
a vehicle data bus, wherein the i-module data bus is connected by means of the gateway to the vehicle data bus.

15. The vehicle seat as claimed in claim 14, wherein each i-module controls an associated apparatus as a local controller to control each apparatus in a decentralized manner.

16. The vehicle seat as claimed in claim 12, wherein the i-modules communicate with one another and match a state of the apparatuses to one another.

17. The vehicle seat as claimed in claim 16, wherein the i-modules activate the electric drives of a respective apparatus in a specific time sequence.

18. The vehicle seat as claimed in claim 11, wherein each i-module is arranged physically adjacent to a connected electric drive or is integrated structurally in the electric drive.

19. The vehicle seat as claimed in claim 15, wherein the i-modules communicate with one another and match a state of the apparatuses to one another.

20. The vehicle seat as claimed in claim 19, wherein the i-modules activate the electric drives of a respective apparatus in a specific time sequence.
